(19) United States
(12) Patent Application Publication
(10) Pub. No.: US 2024/0192473 A1
(43) Pub. Date: Jun. 13, 2024

(54) OFF-AXIS SYSTEM FOR LCD PROJECTORS

(71) Applicant: Sichuan Puju Optoelectronic Technology Co., Ltd, Chengdu (CN)

(72) Inventors: Xiaocheng Huang, Chengdu (CN); Chunfa Song, Chengdu (CN)

(21) Appl. No.: 18/347,193

(22) Filed: Jul. 5, 2023

(30) Foreign Application Priority Data
Dec. 10, 2022 (CN) 2022115843921

(51) Int. Cl. G02B 13/16; G03B 21/00; G03B 21/20

(52) U.S. Cl. CPC G02B 13/16; G03B 21/006; G03B 21/2033; G03B 21/2066

(57) ABSTRACT

An off-axis system for LCD projectors comprises an LED light source, a condenser cup, a rear Fresnel lens, a heat insulation lens, an LCD, a front Fresnel lens, and a projection lens group, provided in sequence from light source to projection screen. The optical axis of the projection lens is inclined upward by 9.5 degrees, the front Fresnel lens is inclined by 3 to 6 degrees, and the LCD projector's base plane is inclined by 9.5 degrees. The invention solves image separation and optical loss by applying to all single-panel LCD projectors. The viewing wall and front lens form a 70-to-75.5-degree angle for keystone correction, and the LED light, condenser cup, rear Fresnel lens, front Fresnel lens and LCD form a 7-to-10-degree angle with the horizontal plane, and the reflection mirror and projection lens group form a 90-degree angle, achieving concentric alignment of optical axis to solve optical loss.

### 1. TECHNICAL FIELD

The invention relates to the field of LED projection, in particular to an off-axis system for LCD projectors.

### 2. BACKGROUND ART

With the continuous expansion of projector applications, the high cost and market sales price of DLP projectors have become a problem to be solved. If LCD single-panel projectors do not have an off-axis setting, the projected image will exhibit a separation phenomenon, and users can only view the image by elevating the product, resulting in a projector keystone phenomenon. Projectors without off-axis settings can only attempt to fix the device in the axial direction of the screen, which is inconvenient for users. For instance, when presenting a PowerPoint presentation, a projector located at the axial position can easily obstruct the audience's view and may shine directly into the presenter's eyes. Furthermore, in the absence of a stand, projectors without off-axis settings will face the problem of a partially missing image. The current market products still have the following shortcomings: LCD projectors without off-axis settings; and DLP projectors with eccentric lenses in front of the projector lens, shifting the center upwards, causing the light path to deviate from the original axis after passing through the eccentric lens, resulting in severe optical loss. Consequently, designing an off-axis system for LCD projectors that can shift the projected image upwards by 100% is an urgent problem to be solved by technical professionals in the relevant field.

### 3. SUMMARY OF THE INVENTION

To solve the above technical problems, the invention provides the following technical solutions: an off-axis system for LCD projectors, wherein comprises an LED light source, a condenser cup, a rear Fresnel lens, a heat insulation lens, an LCD, a front Fresnel lens, and a projection lens group, provided in sequence from the light source to the projection screen; the optical axis of the projection lens is inclined upward by an angle of 9.5 degrees, the front Fresnel lens is inclined at an angle of 3 to 6 degrees, and the base plane of the LCD projector is inclined at an angle of 9.5 degrees.

Preferably, the LED light source, condenser cup, rear Fresnel lens, heat insulation lens, LCD, front Fresnel lens, and projection lens group are provided coaxially, and an illumination lens is provided inside the condenser cup.

Preferably, the LED light source, condenser cup, rear Fresnel lens, heat insulation lens, LCD, and front Fresnel lens are provided coaxially, with the optical axis perpendicular to the optical axis of the projection lens group. A 45-degree reflection mirror is provided between the front Fresnel lens and the projection lens group, to fold the optical axis of the projection lens by 90 degrees and enter the projection lens group.

Compared to the prior arts, the invention has the following advantages and beneficial effects: the off-axis system of the LCD projector can be applied to all fields of single-panel LCD projectors, effectively solving the problem of image separation during application, and the issue of optical loss. The viewing wall and the front lens is provided at an angle of 70 to 75.5 degrees to perform keystone correction, and the LED light, condenser cup, rear Fresnel lens, front Fresnel lens, LCD and the horizontal plane is provided at an angle of 7 to 10 degrees, and the reflection mirror and the projection lens group form a 90-degree angle, achieving the concentric alignment of optical axis and solving the optical loss of DLP projectors.

### 4. BRIEF DESCRIPTION OF ACCOMPANY DRAWINGS

FIG. 1 is a schematic diagram showing the structure of an embodiment 1 of off-axis system for LCD projectors provided by the invention.

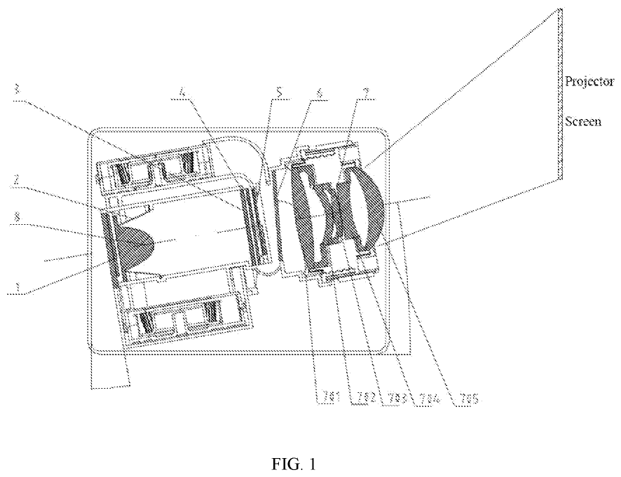

FIG. 2 is a schematic diagram showing the structure of an embodiment 2 of off-axis system for LCD projectors provided by the invention.

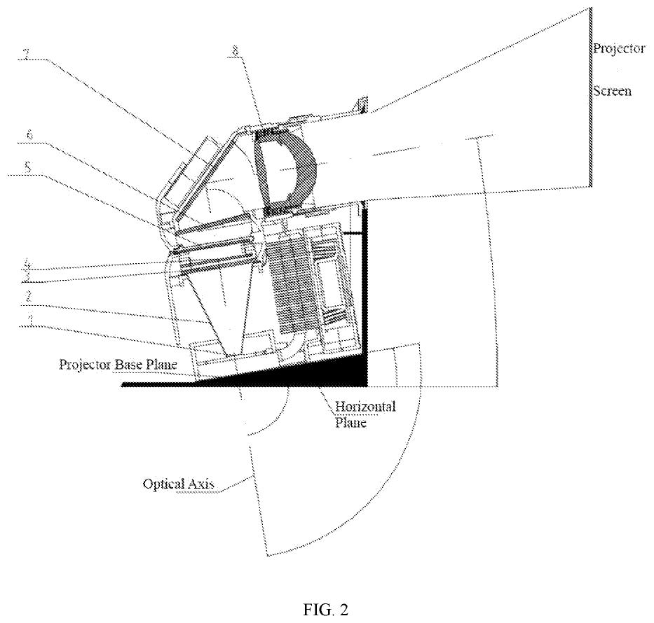

### 5. SPECIFIC EMBODIMENT OF THE INVENTION

To make the purpose, technical solutions and advantages provided by the invention more comprehensible, exemplary embodiments according to the application are described below in detail with reference to the accompanying drawings. Apparently, the described embodiments are merely some embodiments of the application rather than all the embodiments of the application. It should be understood that the application is not limited to the exemplary embodiments described herein. The components of the embodiments of the invention generally described and illustrated in the accompanying drawings herein can be arranged and designed in a variety of different configurations.

In the description of the embodiments of the invention, it also needs to be explained that unless otherwise explicitly stipulated or limited, the orientation or positional relationship indicated by the terms ‘center’, ‘upper’, ‘lower’, ‘left’, ‘right’, ‘vertical’, ‘horizontal’, ‘inner’ and ‘outer’ is based on the orientation or position relationship shown in the accompanying drawings, or the customary orientation or positional relationship when the product of the invention is in use, which is intended only to facilitate the description of the invention and simplify the description, rather than indicating or implying that the indicated device or element must have a specific orientation, be constructed and operated in a particular orientation. Therefore, it cannot be understood as limiting the invention. In addition, the terms ‘first’, ‘second’ and ‘third’ are only used to distinguish the description and should not be understood as indicating or implying relative importance.

In addition, the terms ‘horizontal’, ‘vertical’ and ‘suspended’ do not mean that the components are absolutely horizontal or suspended, but may be slightly inclined. For example, ‘horizontal’ only means that its direction is more horizontal relative to ‘vertical’ and does not mean that the structure must be completely horizontal but may be slightly inclined.

In the description of the embodiments of the invention, ‘multiple’ represents at least two.

In the description of the embodiments of the invention, it should be noted that, unless otherwise indicated or limited, if the terms ‘set’, ‘installed’, ‘provided’, ‘connected’ and ‘connected’ are used, they should be understood broadly. For example, a fixed connection or a detachable connection, or an integral connection; mechanical connection or electrical connection; direct connection or indirect connection through intermediate medium; internal communication of two elements. For ordinary technicians in the art, the specific meaning of the above terms in the invention can be understood according to the specific situation.

### Embodiment 1

The embodiment provides an off-axis system for LCD projectors, specifically comprising:

An off-axis system for LCD projectors comprises the LED light source 1, the condenser cup 2, the rear Fresnel lens 3, the heat insulation lens 4, the LCD 5, the front Fresnel lens 6, and the projection lens group 7, provided in sequence from the light source to the projection screen; the optical axis of the projection lens is inclined upward by an angle of 9.5 degrees, the front Fresnel lens is inclined at an angle of 3 to 6 degrees, and the base plane of the LCD projector is inclined at an angle of 9.5 degrees.

The LED light source 1, the condenser cup 2, the rear Fresnel lens 3, the heat insulation lens 4, the LCD 5, the front Fresnel lens 6, and the projection lens group 7 are provided coaxially, and an illumination lens is provided inside the condenser cup, to guarantee that the projection light path without aperture cutting and the illumination efficiency of the light source reaches 80% or more.

The distance from the LED light source 2 to the light source lens 9 is 1.5 mm; the distance from the light source lens 9 to the rear Fresnel lens 6 is 56.1 mm; the distance from the rear Fresnel lens 3 to the heat insulation lens 4 is 1.7 mm; the distance from the heat insulation lens 4 to the LCD 5 is 2.3 mm; the distance from the LCD 5 to the front Fresnel lens 6 is 9.7 mm, and the distance from the front Fresnel lens 6 to the projection lens group 7 is 10 mm.

The projection lens group 7 comprises the first biconvex lens 701, the first negative meniscus lens 702, the second biconvex lens 703, the first negative lens 704, and the second negative meniscus lens 705, provided in sequence from the front Fresnel lens 6 to the projection screen. The concave surfaces of the first negative meniscus lens 702 and second negative meniscus lens 705 are provided towards the front Fresnel lens, and the concave surface of the first negative lens 704 is provided towards the projection screen. The first biconvex lens 701 and the first negative meniscus lens 702 are spaced apart, and the first negative lens 704 and the second negative meniscus lens 705 are spaced apart, and the first negative meniscus lens 702, the second biconvex lens 703, and the first negative lens 704 are provided in close contact.

### Embodiment 2

This embodiment is a vertical LCD projector off axis system, and compared to embodiment one, this embodiment differs from embodiment 1 in the following aspects:

The LED light source, condenser cup, rear Fresnel lens, heat insulation lens, LCD, and front Fresnel lens are provided coaxially, with the optical axis perpendicular to the optical axis of the projection lens group. A 45-degree reflection mirror is provided between the front Fresnel lens and the projection lens group, to fold the optical axis of the projection lens by 90 degrees and enter the projection lens group.

The distance from the LED light source to the rear Fresnel lens is 46.9 mm; the distance from the rear Fresnel lens to the heat insulation lens is 1.7 mm; the distance from the heat insulation lens to the LCD is 6.6 mm; the distance from the LCD to the front Fresnel lens is 9.7 mm; the distance from the front Fresnel lens to the reflection mirror is 20.8 mm, and the distance from the reflection mirror to the projection lens group is 27.6 mm.

The projection lens group comprises the third biconvex lens and the third negative meniscus lens, provided in sequence from the front Fresnel lens. The concave surface of the third negative meniscus lens is provided towards the reflection mirror; and the third biconvex lens and the third negative meniscus lens are spaced apart.

In the embodiment, the viewing wall and the front lens is provided at an angle of 70 to 75.5 degrees to perform keystone correction, and the LED light, condenser cup, rear Fresnel lens, front Fresnel lens, LCD and the horizontal plane is provided at an angle of 7 to 10 degrees, and the reflection mirror and the projection lens group form a 90-degree angle, achieving the concentric alignment of optical axis and solving the optical loss of DLP projectors.

The invention and the embodiments thereof are described hereinabove, and this description is not restrictive. What is shown in the drawings is only one of the embodiments of the invention, and the actual structure is not limited thereto. In summary, structural methods and embodiments similar to the technical solution without departing from the inventive purpose of the invention made by inspired ordinary technicians in the art without creative efforts shall all fall within the protection scope of the invention.

1. An off-axis system for LCD projectors, wherein comprises an LED light source, a condenser cup, a rear Fresnel lens, a heat insulation lens, an LCD, a front Fresnel lens, and a projection lens group, provided in sequence from the light source to the projection screen; the optical axis of the projection lens is inclined upward by an angle of 9.5 degrees, the front Fresnel lens is inclined at an angle of 3 to 6 degrees, and the base plane of the LCD projector is inclined at an angle of 9.5 degrees.

2. An off-axis system for LCD projectors as claimed in claim 1, wherein the LED light source, the condenser cup, the rear Fresnel lens, the heat insulation lens, the LCD, the front Fresnel lens and the projection lens group are provided coaxially, and an illumination lens is provided inside the condenser cup.

3. An off-axis system for LCD projectors as claimed in claim 2, wherein the distance from the LED light source to the light source lens is 1.5 mm; the distance from the light source lens to the rear Fresnel lens is 56.1 mm; the distance from the rear Fresnel lens to the heat insulation lens is 1.7 mm; the distance from the heat insulation lens to the LCD is 2.3 mm; the distance from the LCD to the front Fresnel lens is 9.7 mm, and the distance from the front Fresnel lens to the projection lens group is 10 mm.

4. An off-axis system for LCD projectors as claimed in claim 3, wherein the projection lens group comprises a first biconvex lens, a first negative meniscus lens, a second biconvex lens, a first negative lens, and a second negative meniscus lens, provided in sequence from the front Fresnel lens to the projection screen.

5. An off-axis system for LCD projectors as claimed in claim 4, wherein the concave surfaces of the first negative meniscus lens and second negative meniscus lens are provided towards the front Fresnel lens, and the concave surface of the first negative lens is provided towards the projection screen.

6. An off-axis system for LCD projectors as claimed in claim 1, wherein the first biconvex lens and the first negative meniscus lens are spaced apart, and the first negative lens and the second negative meniscus lens are spaced apart, and the first negative meniscus lens, the second biconvex lens, and the first negative lens are provided in close contact.

7. An off-axis system for LCD projectors as claimed in claim 6, wherein the LED light source, condenser cup, rear Fresnel lens, heat insulation lens, LCD, and front Fresnel lens are provided coaxially, with the optical axis perpendicular to the optical axis of the projection lens group. A 45-degree reflection mirror is provided between the front Fresnel lens and the projection lens group, to fold the optical axis of the projection lens by 90 degrees and enter the projection lens group.

8. An off-axis system for LCD projectors as claimed in claim 7, wherein the distance from the LED light source to the rear Fresnel lens is 46.9 mm; the distance from the rear Fresnel lens to the heat insulation lens is 1.7 mm; the distance from the heat insulation lens to the LCD is 6.6 mm; the distance from the LCD to the front Fresnel lens is 9.7 mm; the distance from the front Fresnel lens to the reflection mirror is 20.8 mm, and the distance from the reflection mirror to the projection lens group is 27.6 mm.

9. An off-axis system for LCD projectors as claimed in claim 8, wherein the projection lens group comprises a third biconvex lens and a third negative meniscus lens, provided in sequence from the front Fresnel lens to the projection screen.

10. An off-axis system for LCD projectors as claimed in claim 9, wherein the concave surface of the third negative meniscus lens is provided towards the reflection mirror; and the third biconvex lens and the third negative meniscus lens are spaced apart.
